(19) United States
(12) Patent Application Publication
(10) Pub. No.: US 2009/0172008 A1
(43) Pub. Date: Jul. 2, 2009

(54) TEMPLATING VIRTUAL VIEWS IN AN ON-DEMAND PORTAL INFRASTRUCTURE

(75) Inventors: Dharmesh MISTRY, Markham (CA); Kevin Lee SALLY, Markham (CA); Christopher GOODWIN, Surfside, FL (US)

Correspondence Address: AKERMAN SENTERFITT, P.O. BOX 3188, WEST PALM BEACH, FL, 33402-3188, US

(73) Assignee: INTERNATIONAL BUSINESS MACHINES CORPORATION, Armonk, NY (US)

(21) Appl. No.: 11/968,483

(22) Filed: Jan. 2, 2008

(51) Int. Cl. G06F 17/30

(52) U.S. Cl. 707/102; 707/100

(57) ABSTRACT

A computer-implemented method for templating virtual views within an on-demand portal infrastructure is provided. The method includes retrieving a virtual view template identified by a virtual view template identifier in response to a request to render a virtual view of a portal. The method further includes aggregating site profile attributes corresponding to the virtual view with attributes obtained, from the virtual view template referenced by the virtual view template identifier. The attributes obtained from the template profile are distinct from the site profile attributes. The profile attributes and attributes obtained from the virtual view template are used for rendering the virtual view.

### FIELD OF THE INVENTION

The present invention is related to the network communications, and more particularly, to data communications network portals.

### BACKGROUND OF THE INVENTION

A portal can be broadly defined as a network-site application that functions as a point of access to the World Wide Web. A portal typically presents information from diverse sources in a unified way. Aside from a search engine standard, a portal can provide up-to-date news stories, stock prices, various types of “infotainment,” as well as a plethora of other features.

In a commercial context, portals can serve as a mechanism through which enterprises can provide a consistent “look-and-feel” with access control and procedures for multiple applications. Various classes and types of enterprises of all sizes increasingly utilize portals for a variety of internal repositories and applications, many of which have migrated to Web-based technologies. Enterprise portals can be designed to enable worker collaboration in distributed workplaces. Enterprises can develop and utilize multiple enterprise portals based on business structure and strategic focus while reusing architectural frameworks, component libraries, or standardized project methodologies (e.g., business-to-employee (B2E), business-to-customer (B2C), business-to-business (B2B), and business-to-government (B2G)). Another enterprise-related requirement of portals is that the content be able to work on multiple platforms such as personal computers, personal digital assistants (PDAs), and cell phones.

Each distinct portal of an enterprise having multiple portals typically should be unique. In large enterprise, however, there are many commonalities among different portals. As a result the concept of the virtual view is applicable. A virtual view is the creation of a virtual representation of a given portal. Each such virtual view can be defined by a profile, which describes and delineates the manner in which various portal attributes are rendered and/or used. In a certain sense, a virtual view is a mechanism for cloning a single portal into different forms while maintaining one physical portal.

While a virtual view provides significant advantages, the use of one or more virtual views can also give rise to many, indeed potentially thousands, of profiles that must be managed and maintained. The multiple profiles, in turn, can give rise to a large datasets. Thus it can be costly to manage a large number of virtual views, even though many may have many common data points.

### SUMMARY OF THE INVENTION

The present invention is directed to a system, apparatus, and methods for managing and maintaining site-profile data for a collection of virtual views. The common-site profile data can be maintained and managed at a single location. Accordingly, an object of the invention is to template virtual views in an on-demand portal infrastructure so as to efficiently and effectively manage large numbers of virtual views through a common template while still providing the flexibility needed to manage each individual virtual view as a distinct entity. Another object of the invention is to provide a capability to disagreeable a virtual view into multiple data sets, which also allows for a subsequent evolution of templates such that a virtual view can comprise and utilize multiple templates.

### BRIEF DESCRIPTION OF THE DRAWINGS

There are shown in the drawings, embodiments which are presently preferred. It is expressly noted, however, that the invention is not limited to the precise arrangements and instrumentalities shown.

FIG. 1 is a schematic view of a system for templating virtual views within an on-demand portal infrastructure, according to one embodiment of the invention.

FIG. 2 is a schematic view of operative features of the system shown in FIG. 1.

FIG. 3 is a schematic view of the operative steps performed in merging attributes of a site profile and attributes of a corresponding template profile, according to another embodiment of the invention.

FIG. 4 is a flowchart of exemplary steps in a method for templating virtual views within an on-demand portal infrastructure, according yet another embodiment of the invention.

### DETAILED DESCRIPTION

The invention is directed to systems and methods for templating virtual views in an on-demand portal infrastructure. As noted above, a virtual view is a virtual representation of a particular portal that can be accessed in a data communications network environment. The virtual view is defined by a profile, typically implemented in computer-executable code, which specifies various attributes for rendering or using a portal. In one sense, because different virtual views corresponding to a single portal can be created, the virtual view implementation provides a mechanism whereby a single portal is transformed, or “cloned,” into different forms or representations of a particular portal while still maintaining a single physical portal.

Given the very large numbers of virtual views that can be created for even a single, there is the potential challenge of having to manage and maintain perhaps thousands of virtual view profiles. One aspect of the invention is enhanced efficiency in handling the large datasets that comprise profiles corresponding to numerous virtual views—many of which have common data points—utilizing a common template. The common template comprises attributes common among different site profiles corresponding to distinct virtual views. As will be apparent from the description herein, the common template mitigates the burden of managing and maintaining multiple site profiles for different virtual views while also providing flexibility for managing each virtual view as a distinct entity. Another aspect of the invention is the capability to break a given virtual view profile into multiple data sets, allowing the template to evolve so that a virtual view can comprise and/or utilize multiple templates.

Virtual view templates can provide flexible access control of portal and virtual view resources. For example, a portal administrator can control access to a large number of virtual view profiles by utilizing virtual view templates. An enterprise that has thousands of virtual views to manage and maintain can organize the virtual views according to a defined criteria (e.g., according to industry type or geographical location). Accordingly, the portal administrator can create a number of distinct templates, and each virtual view can be based on one of the templates. The portal administrator can then add a new page to a portal, which may only be visible for a certain group of virtual views. Although there is only one underlying portal, the access control that is applied at the portal level nonetheless can apply to all corresponding virtual views. Virtual views allow the portal administrator to manage access control of the page via a site profile; a page can be hidden for one virtual view, but enabled for another. Templates extend this feature by allowing the page entitlement to be set once within the template, thereby propagating the entitlement to a number of virtual views corresponding to the template. Moreover, a virtual view can override an attribute of a parent template, thus breaking the link and avoiding template updates from propagating to a corresponding virtual view.

Other areas in which templates provide more flexible access control with respect to processing, storage, and other resources include, portlet instance entitlement, content entitlement, and geographic-specific attributes. In contrast to virtual view profiles, virtual view templates greatly reduce the amount of redundant data and maintenance overhead when virtual views are used in an on-demand portal infrastructure; for example, instead of having to update many virtual views for a change in the site profile for a group of virtual views, the portal administrator need only update a single template.

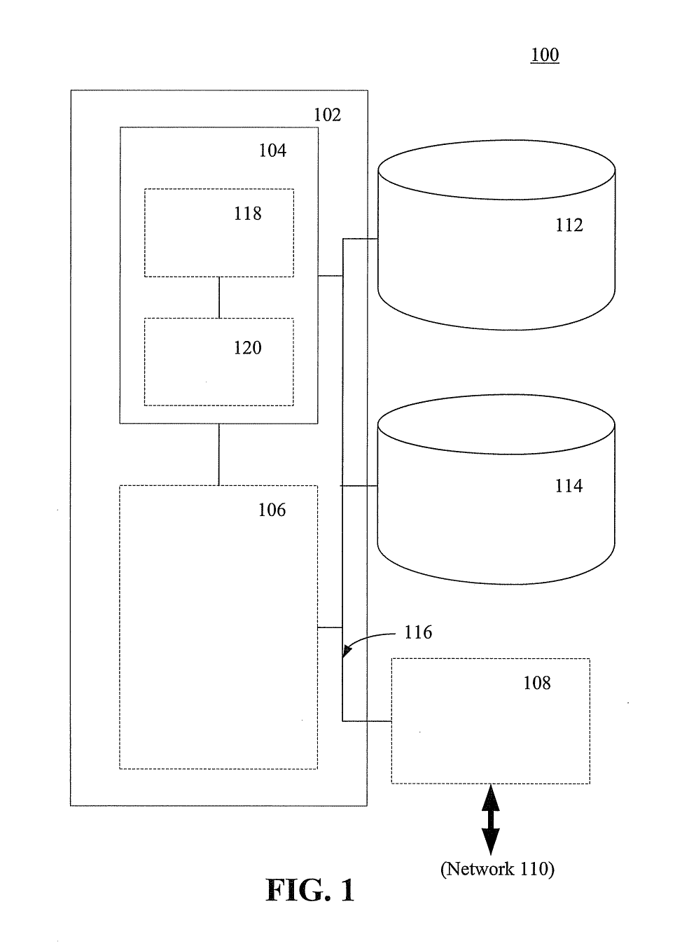

FIG. 1 is a schematic view of a system 100 for templating virtual views within an on-demand portal infrastructure, according to one embodiment of the invention. The system 100 illustratively comprises a computing device 102, such as a general-purpose or application-specific computer, having one or more processors 104 (illustratively shown as a single processor) that execute computer-readable code. Optionally, the computing device 102 can further include a memory storage element 106, such as a volatile primary memory, and at least one input/output device (I/O) 108. The I/O device 108, more particularly, can provide a data communications link between the computing device 102 and a data communications network 110, such as the Internet.

The system 100 also illustratively includes an electronically stored template profile 112 and n electronically stored site profiles 114. Each of the site profiles 114 specifies the attributes for rendering and/or using a corresponding virtual view of a physical portal. The template profile 112

The stored template profile 112 and the stored site profiles 114 are shown as distinct databases stored in memory external to the computing device 102, in for example non-volatile secondary memory. It is to be noted that one or both of the template profile 112 and the stored site profile 114 can stored remotely from the computing device 102 and accessed via a bus 16 communicatively linking the various elements of the computing device and/or through the communications link to the network 110.

Additionally, the system 100 illustratively includes an aggregated site profile generating module 118 and a virtual view rendering module 120, each for performing the respective procedures and functions described more particularly below. The aggregated site profile generating module 118 and the virtual view rendering module 120 can be implemented in processor-executable code that when loaded in and executed by the processor 104 causes the computing device 102 to perform the procedures and functions for templating virtual views described herein. In an alternate embodiment, however, one or both the aggregated site profile generating module 118 and/or the virtual view rendering module 120 can be implemented in dedicated hardwired circuitry. In still another embodiment, the aggregated site profile generating module 118 and/or the virtual view rendering module 120 can be implemented in a combination of circuitry and code.

Operatively, regardless of the particular implementation, the aggregated site profile generating module 118 aggregates site profile attributes contained in a site profile with attributes obtained from the template profile. According to one embodiment, the template profile can be referenced by a virtual view template identifier in response to a request to render a virtual view of a portal. The virtual view rendering module 120 operates cooperatively with the aggregated site profile generating module 118 to render a virtual view identified by a virtual view identifier and based upon the aggregated site profile attributes.

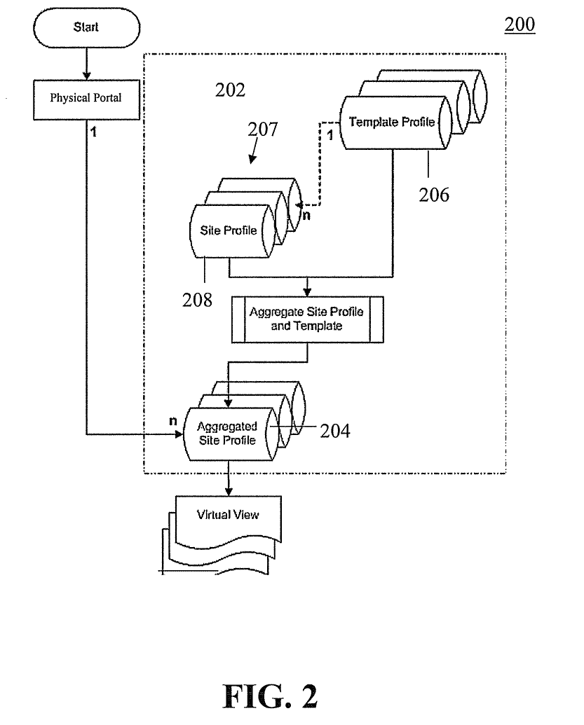

Referring additionally to FIG. 2, various aspects of these operative features 200 of the aggregated site profile generating module 118 and the virtual view rendering module 120 are schematically illustrated. The schematic region 202 illustrates the generation of an aggregate site profile 204. As illustrated, one template profile 206 can be referenced by n site profiles 207. Although illustratively described in terms of a single template profile, the system 100 also allows multiple templates, and accordingly different template profiles, to be utilized for grouping different sets of the n site profiles.

The site profiles 207 and template profile 206, as already described, can be electronically stored in memory. When a virtual view is to be rendered, the system 100 can utilize the virtual view identifier to identify which profile 208 among the plurality of site profiles 207 to load in order to execute and render the virtual view. In response to a request for a site profile, the aggregated site profile generating module 118 can initially retrieve the correct site profile 208 from memory. In a particular embodiment, the aggregated site profile generating module 118 can extract a template ID from the site profile 208. Subsequently, based upon the template ID, the aggregated site profile generating module 118 can retrieve the corresponding template profile 206. The aggregated site profile generating module 118 can then combine the attributes of both to generate an aggregated site profile for a particular virtual view. The aggregated site profile can be stored, for example, within a web request as a java object.

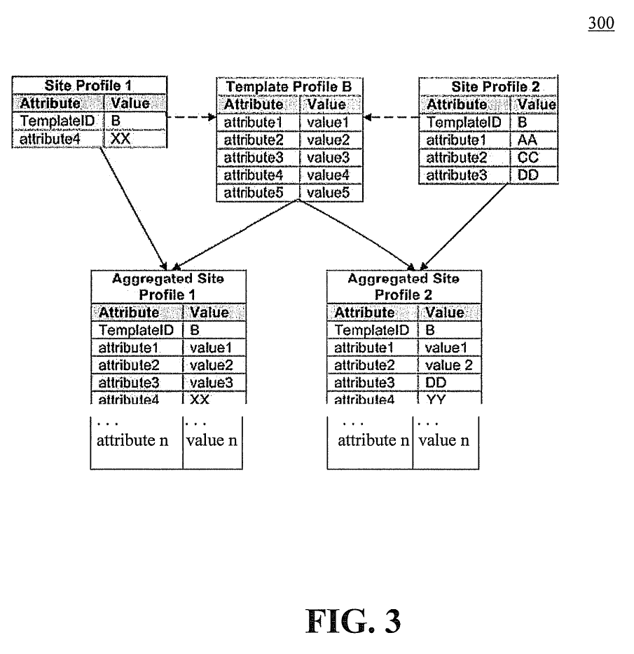

Referring additionally to FIG. 3, exemplary procedural steps 300 of merging attributes of a site profile and attributes of a corresponding template profile are schematically illustrated. The exemplary steps 300 illustrate that the aggregation of template profile and site profile attributes can be performed in such a manner that the site profile can “override” the template profile in the sense described herein. Illustratively, Site Profile 1 corresponds to Template Profile B. Site profile 1 and Template B are merged to generate Aggregate Site Profile 1. Initially, all attributes are loaded from Site Profile 1. Subsequently any attributes that reside in Template Profile B but not Site Profile 1 are merged with the existing attributes of Site Profile 1. As shown, Site Profile 1 contains two attributes (TemplateID having value “B” and attributed having value “XX”). Those attributes in Template Profile B but not in Site Profile 1 (attribute1, attribute2, attribute3, and attribute 5) are merged with templateID and attributed from Site Profile 1. Thus attribute4 is not taken from the template profile since Site Profile 1 is already populated with attributed. As a result, aggregated Site Profile 1 is generated, the aggregated site profile comprising attribute1, attribute2, attribute3, attributed, attribute 5, and TemplateID.

FIG. 3 further illustrates that the majority of attributes for both Site Profile 1 and Site Profile 2 can be maintained in Template Profile B. Accordingly, relatively few attributes and their corresponding value need be stored in either Site Profile 1 or Site Profile 2. When attributes are needed for rendering a virtual view based on two different sets of attributes, the merging of common attributes stored in Template Profile B generates the respective aggregated profile needed for rendering the different virtual views.

Moreover, as further illustrated in FIG. 3, if, for example, attributed which is a common attribute for rendering both virtual views were changed, it is only necessary to effect the change in Template Profile B since the generation of the respective aggregated site profiles utilized in rendering the different virtual views supplies attributed and its corresponding value. Conversely, if attribute3, contained only in Template Profile B, is changed, the change is propagated only to Aggregated Site Profile 1, since it is not needed for rendering the virtual view based on a different set of attributes. Accordingly, the system 100 can also include an updating module, implemented in executable code and/or dedicated circuitry, for updating at least one template value, which can subsequently be propagated through one or more aggregated site profiles.

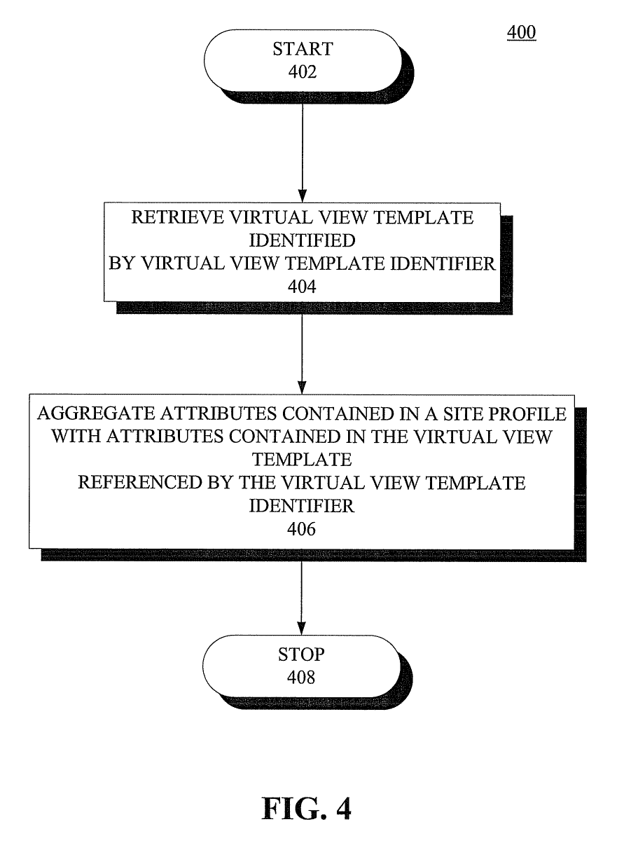

Certain of the method aspects of the invention are illustrated by the flowchart of FIG. 4. The flowchart illustrates exemplary steps of a computer-implemented method 400 for templating virtual views within an on-demand portal infrastructure. After the start at step 402, the method 400 illustratively includes responding to a request to render a virtual view of a portal by retrieving a virtual view template identified by a virtual view template identifier at step 404. The method further illustratively includes aggregating site profile attributes corresponding to the virtual view with attributes obtained from template profile referenced by the virtual view template identifier at step 406. According to the method 400, more particularly, the attributes obtained from the template profile are distinct from the site profile attributes. So combined, the profile attributes and common attributes can be used for rendering the virtual view of the requested portal. The method illustratively concludes at step 408.

The method 400, according to another embodiment, can further include selecting which among a plurality of site profiles to load to a system for rendering the virtual view, wherein each site profile comprises a different set of site profile attributes. Moreover, the selection can be based upon the virtual view template identifier. According to still another embodiment, the method 400 also can include retrieving the selected site profile prior to aggregating the site profile attributes and the attributes obtained from the virtual view template. The virtual view template can be referenced by the site profile and a plurality of other, different site profiles.

In the method 400, the retrieving step, according to yet another embodiment, can comprise locating and aggregating all common attributes contained in the virtual view template. In yet another embodiment of the method 400, the retrieving step can comprise locating and aggregating view-specific data from the site profile.

Optionally, according another embodiment, the method 400 also can include initially retrieving a site profile comprising the site profile attributes and extracting from the retrieved site profile the virtual view template identifier. According to still another embodiment, the method 400 further can include updating at least one value of an attribute contained in the virtual view template and propagating the at least one updated value through the aggregated site profile.

The invention, as already noted, can be realized in hardware, software, or a combination of hardware and software. The invention can be realized in a centralized fashion in one computer system, or in a distributed fashion where different elements are spread across several interconnected computer systems. Any kind of computer system or other apparatus adapted for carrying out the methods described herein is suited. A typical combination of hardware and software can be a general purpose computer system with a computer program that, when being loaded and executed, controls the computer system such that it carries out the methods described herein.

The invention, as also already noted, can be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

The foregoing description of preferred embodiments of the invention have been presented for the purposes of illustration. The description is not intended to limit the invention to the precise forms disclosed. Indeed, modifications and variations will be readily apparent from the foregoing description. Accordingly, it is intended that the scope of the invention not be limited by the detailed description provided herein.

We claim:

1. A computer-implemented method for templating virtual views within an on-demand portal infrastructure, the method comprising:
in response to a request to render a virtual view of a portal, retrieving a virtual view template identified by a virtual view template identifier; and
aggregating site profile attributes corresponding to the virtual view with attributes obtained from the virtual view template referenced by the virtual view template identifier, wherein the attributes obtained from the template profile are distinct from the site profile attributes;
wherein the profile attributes and attributes obtained from the virtual view template are used for rendering the virtual view.

2. The method of claim 1, further comprising selecting based upon the virtual view template identifier which among a plurality of site profiles to load to a system for rendering the virtual view, each site profile comprising a different set of site profile attributes.

3. The method of claim 2, comprising retrieving the selected site profile prior to aggregating the site profile attributes and the attributes obtained from the virtual view template.

4. The method of claim 3, wherein the virtual view template is referenced by the site profile and a plurality of other, different site profiles.

5. The method of claim 1, wherein the retrieving step comprises locating and aggregating all common attributes contained in the virtual view template.

6. The method of claim 1, wherein the retrieving step comprises locating and aggregating view-specific data from the site profile.

7. The method of claim 1, further comprising initially retrieving a site profile comprising the site profile attributes and extracting from the retrieved site profile the virtual view template identifier.

8. The method of claim 1, further comprising updating at least one value of an attribute contained in the virtual view template and propagating the at least one updated value through the aggregated site profile.

9. A computer-based system for templating virtual views within an on-demand portal infrastructure, the system comprising:
a computer comprising at least one processor;
an electronically stored template profile;
an electronically stored site profile;
an aggregated site profile generating module for generating an aggregated site profile by combining attributes contained in the site profile with attributes obtained from the template profile, wherein the template profile is referenced by a virtual view template identifier in response to a request to render a virtual view of a portal, and wherein the attributes obtained from the template profile are distinct from the site profile attributes; and
a virtual view rendering module that executes on the at least one processor to render a virtual view based upon the aggregated site profile attributes.

10. The system of claim 9, wherein the virtual view rendering module is configured to respond to a request to render the virtual view by retrieving the site profile prior to aggregating the site profile attribute and common attributes.

11. The system of claim 10, wherein the virtual view rendering module is further configured to extract from the retrieved site profile a template profile identifier identifying the template profile.

12. The system of claim 9, further comprising an updating module for updating at least one value of an attribute contained in the virtual view template, wherein the at least one updated value can be propagated through the aggregated site profile.

13. A computer-readable storage medium having embedded therein computer-readable code that when loaded in and executed by a computer cause the computer to:
retrieve a virtual view template identified by a virtual view template identifier in response to a request to render a virtual view of a portal; and
aggregate site profile attributes corresponding to the virtual view with attributes obtained from the virtual view template referenced by the virtual view template identifier, wherein the attributes obtained from the template profile are distinct from the site profile attributes, and wherein the profile attributes and attributes obtained from the virtual view template are used for rendering the virtual view.

14. The computer-readable storage medium of claim 13, further comprising computer-readable code for causing the computer to select, based upon the virtual view template identifier, which among a plurality of site profiles to load to a system for rendering the virtual view, each site profile comprising a different set of site profile attributes.

15. The computer-readable storage medium of claim 14, further comprising computer-readable code for causing the computer to retrieve the selected site profile prior to aggregating the site profile attributes and the attributes obtained from the virtual view template.

16. The computer-readable storage medium of claim 15, wherein the virtual view template is referenced by the site profile and a plurality of other, different site profiles.

17. The computer-readable storage medium of claim 13, wherein the retrieving step comprises locating and aggregating all common attributes contained in the virtual view template.

18. The computer-readable storage medium of claim 13, wherein the retrieving step comprises locating and aggregating view-specific data from the site profile.

19. The computer-readable storage medium of claim 13, further comprising computer-readable code for causing the computer to initially retrieve a site profile comprising the site profile attributes and extracting from the retrieved site profile the virtual view template identifier.

20. The computer-readable storage medium of claim 13, further comprising computer-readable code for causing the computer to updating at least one value of an attribute contained in the virtual view template, wherein the at least one updated value is propagated through the aggregated site profile.
